(19) United States
(12) Patent Application Publication
(10) Pub. No.: US 2017/0191569 A1
(43) Pub. Date: Jul. 6, 2017

(54) VACUUM-PUMPING DEVICE AND METHOD FOR OPERATING THE SAME

(71) Applicant: BOE TECHNOLOGY GROUP CO., LTD., Beijing (CN)

(72) Inventors: Xuefei SUN, Beijing (CN); Zhengliang LI, Beijing (CN); Jianhua DU, Beijing (CN)

(73) Assignee: BOE TECHNOLOGY GROUP CO., LTD., Beijing (CN)

(21) Appl. No.: 15/235,441

(22) Filed: Aug. 12, 2016

(30) Foreign Application Priority Data
Dec. 31, 2015 (CN) 201511030602.2

(51) Int. Cl. F16K 3/02

(52) U.S. Cl. CPC F16K 3/0218

(57) ABSTRACT

The present disclosure provides a vacuum-pumping device and a method for operating the vacuum-pumping device. The vacuum-pumping device includes an outer casing, a chamber defined by the outer casing, and a sealing cover. The outer casing includes a through-hole region where a plurality of through-holes is provided, the sealing cover is connected to the outer casing and capable of moving between a first state in which the through-holes are covered by the sealing cover to seal the chamber, and a second state in which at least parts of the through-holes are not covered by the sealing cover to form channels for the chamber.

### CROSS-REFERENCE TO RELATED APPLICATIONS

This application claims priority to Chinese application No. 201511030602.2, filed Dec. 31, 2015, which is hereby incorporated by reference in its entirety.

### TECHNICAL FIELD

The present disclosure relates to the field of manufacture of display devices, in particular to a vacuum-pumping device and a method for operating the vacuum-pumping device.

### BACKGROUND

During the manufacture of liquid crystal display devices, several processes need to be performed within a vacuum chamber, which is configured to provide a vacuum environment or any other environments where gases are filled during the manufacture of electronic components.

When providing the vacuum environment, one vacuum chamber in the related art is usually provided with merely one opening, through which a vacuum-pumping operation is performed using a pump. When providing other environments, one vacuum chamber in the related art is provided with two openings, one of which is used for the vacuum-pumping operation, and the other one of which is used for a gas-filling operation.

During the vacuum-pumping or gas-filling operation, a speed of an air stream is controlled by the pump, so the instable air stream may occur. In addition, for the sake of air-tightness, it is required to control an area ratio of the opening relative to the vacuum chamber within a certain range. In the case of a too large opening, the instable air stream will occur in the vacuum chamber, and in the case of a too small opening, it will take a long time to create the vacuum or fill the gas. Hence, there is an urgent need to improve the structure of the vacuum chamber in the related art so as to ensure the vacuum-pumping or gas-filling efficiency as well as the air-tightness.

### SUMMARY

An object of the present disclosure is to provide a vacuum-pumping device and a method for operating the vacuum-pumping device, so as to ensure the air-tightness as well as the vacuum-pumping or gas-filling efficiency.

In one aspect, the present disclosure provides in some embodiments a vacuum-pumping device, including an outer casing, a chamber defined by the outer casing, and a sealing cover. The outer casing includes a through-hole region where a plurality of through-holes is provided, and the sealing cover is connected to the outer casing and capable of moving between a first state in which the through-holes are covered by the sealing cover so as to seal the chamber, and a second state in which at least parts of the through-holes are not covered by the sealing cover so as to form channels for the chamber.

Alternatively, the through-hole region includes a first through-hole area where a plurality of through-holes is provided and a second through-hole area where a plurality of through-holes is provided, and the sealing cover includes a first sealing cap for the first through-hole area and a second sealing cap for the second through-hole area.

Alternatively, the sealing cover includes a plurality of sealing caps, the number of the sealing caps is identical to the number of the through-holes, and the sealing caps correspond to the through-holes in a one to one manner; each of the sealing caps is capable of moving between a position where the through-hole corresponding to the each of the sealing caps is covered and a position where at least a portion of the through-hole corresponding to the each of the sealing caps is exposed.

Alternatively, in the first state, each of the sealing caps is at the position where the through-hole corresponding to the each of the sealing caps is covered; and in the second state, at least parts of the sealing caps are each located at a position for exposing at least a portion of the corresponding through-hole.

Alternatively, the sealing cover is provided with a plurality of openings; in the first state, the through-hole region is covered by the sealing cover with the openings not overlapping the through-holes in the through-hole region; and in the second state, the through-hole region is covered by the sealing cover with the openings at least partially overlapping the through-holes in the through-hole region.

Alternatively, the sealing cover is of a shape identical to the through-hole region, and attached onto the outer casing in both the first state and the second state.

Alternatively, the vacuum-pumping device further includes a driving mechanism configured to drive the sealing cover to move between the first state and the second state.

Alternatively, the driving mechanism includes a pump connected to the sealing cover via a pneumatic pipe and a pneumatic valve arranged on the pneumatic pipe.

In another aspect, the present disclosure provides in some embodiments a method for operating the above-mentioned vacuum-pumping device, including steps of: moving the sealing cover to be in the second state to expose a plurality of through-holes, and pumping air out of the chamber via a pump in communication with the through-holes exposed outside of the sealing cover; and sealing the chamber by moving the sealing cover to be in the first state when a vacuum degree within the chamber reaches a first predetermined value.

Alternatively, the through-hole region at the outer casing of the vacuum-pumping device includes a first through-hole area where a plurality of through-holes is provided and a second through-hole area where a plurality of through-holes is provided; and the sealing cover includes a first sealing cap for the first through-hole area and a second sealing cap for the second through-hole area; the step of moving the sealing cover to be in the second state to expose a plurality of through-holes, and pumping air out of the chamber via the pump in communication with the through-holes exposed outside of the sealing cover, includes: moving the first sealing cap for the first through-hole area to be in the first state, and moving the second sealing cap for the second through-hole area to be in the second state.

Alternatively, subsequent to the step of sealing the chamber by moving the sealing cover to be in the first state when the vacuum degree within the chamber reaches the first predetermined value, the method further includes: moving the second sealing cap for the second through-hole area to be in the first state, moving the first sealing cap for the first through-hole area to be in the second state so as to expose a plurality of through-holes in the first through-hole area, and filling a gas into the chamber via another pump in communication with the through-holes exposed in the first through-hole area; and sealing the chamber by moving the first sealing cap for the first through-hole area to be in the first state when the vacuum degree within the chamber reaches a second predetermined value.

Alternatively, in the step of moving the second sealing cap for the second through-hole area to be in the second state, merely parts of the through-holes in the second through-hole area are exposed outside of the second sealing cap; in the step of moving the first sealing cap for the first through-hole area to be in the second state, merely parts of the through-holes in the first through-hole area are exposed outside of the first sealing cap.

Alternatively, the sealing cover includes a plurality of sealing caps, the number of the sealing caps is identical to the number of the through-holes, and the sealing caps correspond to the through-holes in a one-to-one manner; the step of moving the sealing cover to be in the second state includes: moving the sealing caps to positions where at least a portion of some of the through-holes is exposed; the step of moving the sealing cover to be in the first state includes: moving each of the sealing caps to a position where each of the sealing caps seals the corresponding through-hole.

Alternatively, the sealing cover is provided with a plurality of openings; the step of moving the sealing cover to be in the second state includes: moving the sealing cover until the openings in the sealing cover at least partially overlap the through-holes; the step of moving the sealing cover to be in the first state includes: moving the sealing cover until the openings in the sealing cover do not overlap the through-holes.

According to the embodiments of the present disclosure, the sealing cover may be moved so as to seal parts of the through-holes in accordance with the practical need, and the vacuum-pumping operation or the gas-filling operation may be performed through the exposed through-holes at the same time. As a result, it is able to ensure the air-tightness of the chamber as well as the vacuum-pumping or gas-filling efficiency.

### DESCRIPTION OF THE DRAWINGS

FIG. 1 is a schematic view showing a vacuum-pumping device according to one embodiment of the present disclosure;

FIG. 2 is a schematic view showing a vacuum-pumping device according to another embodiment of the present disclosure;

FIG. 3 is a schematic view showing a vacuum-pumping device according to yet another embodiment of the present disclosure;

FIG. 4A is a schematic view showing a vacuum-pumping device in a first state according to one embodiment of the present disclosure; and

FIG. 4B is a schematic view showing the vacuum-pumping device in a second state according to one embodiment of the present disclosure.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

The present disclosure will be described hereinafter in conjunction with the drawings and embodiments. The following embodiments are for illustrative purposes only, but shall not be used to limit the scope of the present disclosure.

The present disclosure provides in some embodiments a vacuum-pumping device, which includes an outer casing, a chamber defined by the outer casing, and a sealing cover. The outer casing includes a through-hole region where a plurality of through-holes is provided. The sealing cover is connected to the outer casing and capable of moving between a first state and a second state.

At the first state, the through-holes are covered by the sealing cover and then the chamber is sealed. At the second state, at least some of the through-holes are not covered by the sealing cover to form channels for the chamber.

As compared with the related art where the vacuum-pumping operation or the gas-filling operation is performed through merely one opening, through the vacuum-pumping device in the embodiments of the present disclosure, the sealing cover is movable and may be moved to seal some of the through-holes in accordance with practical needs, and the vacuum-pumping operation or the gas-filling operation may be performed through a plurality of exposed through-holes at the same time. As a result, it is able to ensure the air-tightness of the chamber as well as the vacuum-pumping or gas-filling efficiency.

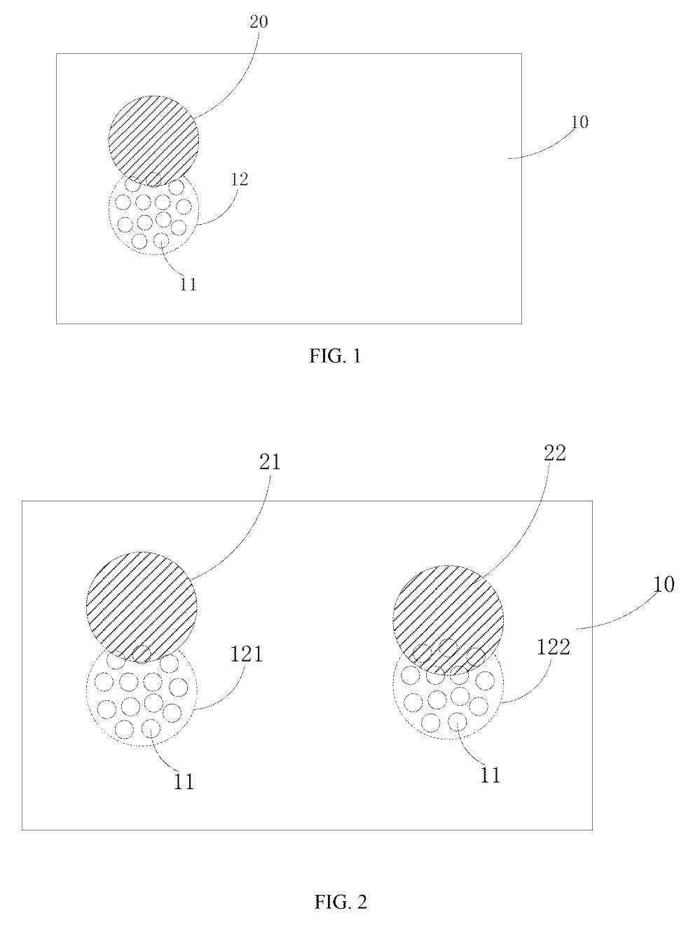

FIG. 1 is a schematic view of partial structures of a vacuum-pumping device according to one embodiment of the present disclosure. As shown in FIG. 1, the vacuum-pumping device includes an outer casing 10, and a chamber defined by the outer casing 10. The chamber is to provide a vacuum environment or another environment where a gas is filled for the manufacture of an electronic component. FIG. 1 merely shows the through-holes in the outer casing 10 for the vacuum-pumping or gas-filling operation, and an overall structure of the vacuum-pumping device shall be known by a person skilled in the art based on the contents of present disclosure.

A plurality of through-holes 11 is provided in the outer casing 10 at a certain region, i.e., a through-hole region 12. In addition, the vacuum-pumping device further includes a sealing cover 20 connected to the outer casing 10 and capable of moving between a first state and a second state.

In one embodiment, merely one sealing cover 20 is provided. Optionally, the sealing cover 20 is of a shape and a size identical to the through-hole region 12. Since the sealing cover 20 is movable, thus the sealing cover 20 may be moved to a position where the sealing cover 20 entirely covers the through-hole region 12. As a result, each through-hole 11 is covered by the sealing cover 20 and then the chamber is sealed. Also, the sealing cover 20 may be moved to a position where the sealing cover 20 partially covers or does not cover the through-hole region 12, thereby to expose parts of, or all of, the through-holes 11. The exposed through-holes 11 define channels between the chamber and the outside, so as to facilitate the vacuum-pumping or gas-filling operation.

To be specific, the sealing cover 20 may be connected to the outer casing 10 via a rotatable shaft. The sealing cover 20 may be moved relative to the outer casing 10 manually, or automatically via a driving mechanism. Through the driving mechanism, the sealing cover 20 may be moved between the first state in which all the through-holes 11 are covered by the sealing cover 20 and the second state in which at least parts of the through-holes 11 are not covered by the sealing cover 20. For example, the driving mechanism may include a pump connected to the sealing cover 20 via a pneumatic pipe and a pneumatic valve arranged on the pneumatic pipe. The sealing cover 20 may be moved between the first state and the second state by controlling the pneumatic valve. The mechanism for controlling the movement of the sealing cover 20 is not the focus of the present disclosure, so it will not be particularly defined herein.

When the vacuum-pumping operation is started, the sealing cover 20 may be moved, for example, rotated, so as to expose parts of, or all of, the through-holes 11, thereby to perform the vacuum-pumping operation through the exposed through-holes 11. During the vacuum-pumping operation, the number of the exposed through-holes 11 may be adjusted by adjusting the position of the sealing cover 20, so as to provide a stable air stream and adjust a variation speed of the vacuum degree within the chamber. In this way, it is able to ensure the air-tightness of the chamber as well the vacuum-pumping efficiency. When the vacuum degree within the chamber reaches a predetermined value, the sealing cover 20 may be moved to a position where the sealing cover 20 covers the entire through-hole region 12, and then all of the through-holes 11 are sealed, thereby sealing the chamber.

FIG. 2 is a schematic view of partial structures of a vacuum-pumping device according to one embodiment of the present disclosure. As shown in FIG. 2, the vacuum-pumping device includes an outer casing 10, and a chamber defined by the outer casing 10. The chamber is to provide a vacuum environment or other environment where a gas is filled during the manufacture of an electronic component. A plurality of through-holes 11 is provided in the outer casing 10 at two regions, i.e., a first through-hole area 121 and a second through-hole area 122.

In FIG. 2, the sealing cover includes two sealing caps including a first sealing cap 21 and a second sealing cap 22. The first sealing cap 21 is arranged corresponding to the first through-hole area 121, and optionally, the first sealing cap 21 is of a shape and a size identical to the first through-hole area 121. The second sealing cap 22 is arranged corresponding to the second through-hole area 122, and optionally, the second sealing cap 22 is of a shape and a size identical to the second through-hole area 122. In addition, the first sealing cap 21 and the second sealing cap 22 may be moved relative to the first through-hole area 121 and the second through-hole area 122, respectively, so as to cover all the through-holes 11 or expose at least parts of the through-holes 11, thereby to form the channels for the vacuum-pumping or gas-filling operation.

To be specific, the first sealing cap 21 and the second sealing cap 22 may each be connected to the outer casing 10 in a manner as mentioned above.

When the vacuum-pumping operation is started, the first sealing cap 21 may be moved to a position where the first sealing cap 21 covers the entire first through-hole area 121 and seals the through-holes in the first through-hole area 121. Meanwhile, the second sealing cap 22 may be moved, for example, rotated to a position where parts of, or all of, the through-holes 11 in the second through-hole area 122 are exposed for the vacuum-pumping operation. When the vacuum degree within the chamber reaches a predetermined value, the second sealing cap 22 may be rotated to a position where the second sealing cap 22 covers the entire second through-hole area 122 and seals the through-holes in the second through-hole area 122. Then, the first sealing cap 21 may be rotated to a position where parts of, or all of, the through-holes 11 in the first through-hole area 121 are exposed for the gas-filling operation. When the vacuum degree within the chamber reaches another predetermined value, the first sealing cap 21 may be rotated to the position where the first sealing cap 21 covers the entire first through-hole area 121 and then seals the entire chamber.

As mentioned above, the through-holes in different through-hole regions may be used for the vacuum-pumping and gas-filling operations, and meanwhile the number of the through-holes may be adjusted by moving the sealing caps. As a result, it is able to ensure the air-tightness of the chamber as well as the vacuum-pumping or gas-filling efficiency.

Further, when two through-hole regions are provided, partial portions of the first through-hole area 121 and the second through-hole area 122 may be covered by the first sealing cap 21 and the second sealing cap 22, respectively, so as to expose parts of the through-holes in the first through-hole area 121 and the second through-hole area 122. At this time, the number of the exposed through-holes 11 in the first through-hole area 121 may be identical to the number of the exposed through-holes 11 in the second through-hole area 122. The exposed through-holes 11 in the first through-hole area 121 may be used for the vacuum-pumping operation, and the exposed through-holes 11 in the second through-hole area 122 may be used for the gas-filling operation, so as to provide airflow within the entire chamber.

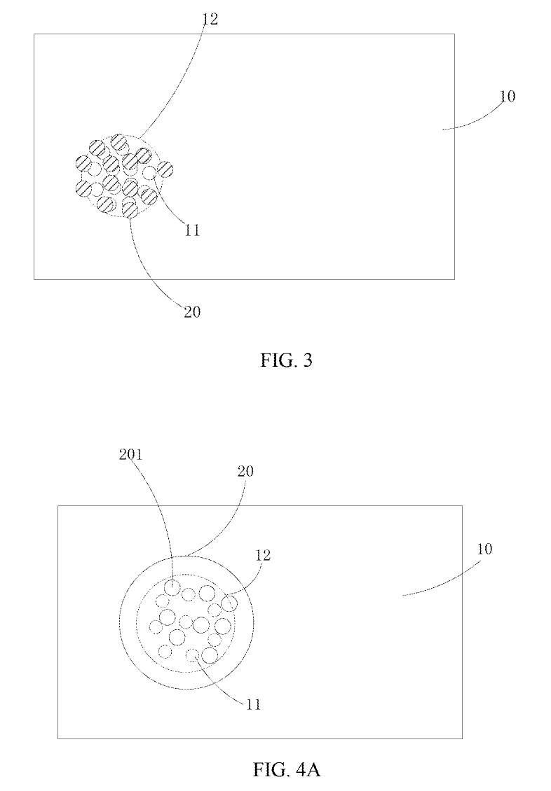

FIG. 3 is a schematic view of partial structures of a vacuum-pumping device according to one embodiment of the present disclosure. As shown in FIG. 3, the vacuum-pumping device includes an outer casing 10, and a chamber defined by the outer casing 10. The chamber is to provide a vacuum chamber or other environment where a gas is filled during the manufacture of an electronic component. The vacuum-pumping device further includes a sealing cover 20 connected to the outer casing 10. As shown in FIG. 3, the sealing cover 20 may include a plurality of sealing caps. The number of the sealing caps may be identical to the number of through-holes 11 provided in the outer casing 10. Each sealing cap is provided for one of the through-holes 11. Each sealing cap may be moved between a position where the corresponding through-hole 11 is covered and a position where at least a portion of the corresponding through-hole 11 is exposed.

When a chamber is at a first state, each through-hole 11 is covered by the corresponding sealing cap so as to seal the chamber. When the chamber is at a second state, at least a portion of each of some of the through-holes 11 is not covered by the corresponding sealing cap so as to form the channels for the vacuum-pumping or gas-filling operation.

In FIG. 3, the sealing cap may be provided for each through-hole 11 and controlled separately, and the number of the through-holes for the vacuum-pumping or gas-filling operation may be selected in accordance with the practical need. As a result, it is able to ensure the air-tightness of the chamber as well as the vacuum-pumping or gas-filling efficiency.

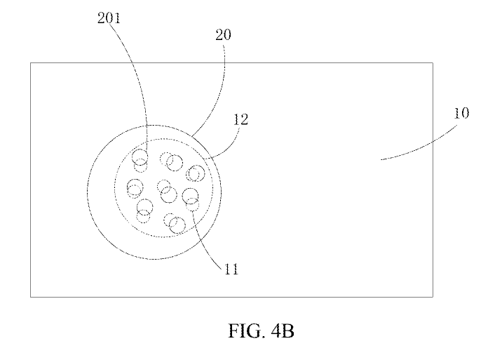

FIGS. 4A and 4B are schematic view of partial structures of a vacuum-pumping device according to one embodiment of the present disclosure. As shown in FIGS. 4A and 4B, the vacuum-pumping device includes an outer casing 10, and a chamber defined by the outer casing 10. The chamber is to provide a vacuum chamber or other environment where a gas is filled during the manufacture of an electronic component. FIGS. 4A and 4B merely show through-holes in the outer casing 10 for the vacuum-pumping or gas-filling operation.

The outer casing 10 is provided with a plurality of through-holes 11 in a certain region, i.e., the through-hole region 12. In addition, the vacuum-pumping device further includes a sealing cover 20 connected to the outer casing 10 and capable of moving between the first state and the second state.

Different from the sealing cover 20 in FIG. 1, in FIGS. 4A and 4B, the sealing cover 20 is provided with a plurality of openings 201. The sealing cover 20 is attached onto the outer casing 10 both in the first state and the second state, merely with different positions of the sealing cover 20 relative to the through-hole region 12. To be specific, in the first state, the through-hole region 12 is covered by the sealing cover 20, and each opening 201 in the sealing cover 20 does not overlap the corresponding through-hole 11, so as to seal the chamber, as shown in FIG. 4a. In the second state, the through-hole region 12 is covered by the sealing cover 20, and openings 201 in the sealing cover 20 at least partially overlap the through-holes 11, so as to form the channel between the chamber and the outside for the vacuum-pumping or gas-filling operation.

Of course, in FIGS. 4A and 4B, two through-hole regions may also be provided, one for the vacuum-pumping operation and the other for the gas-filling operation.

When the vacuum-pumping operation is started, the sealing cover 20 may be rotated to a position where the openings 201 at least partially overlap the through-holes 11, thereby to perform the vacuum-pumping operation through the exposed through-holes 11. During the vacuum-pumping operation, an overlapping area between the openings 201 and the through-holes 11 may be adjusted by moving the sealing cover 20, so as to provide a stable air stream and adjust a variation speed of the vacuum degree within the chamber. In this way, it is able to ensure the air-tightness of the chamber as well as the vacuum-pumping efficiency. When the vacuum degree within the chamber reaches a predetermined value, the sealing cover 20 may be rotated to a position where the openings 201 do not to overlap the through-holes 11, thereby to seal the chamber.

In the vacuum-pumping device in FIGS. 1-2 and 4A-4B, the sealing cover may be of a shape identical to the through-hole region. In the first state and the second state, the sealing cover may be attached onto the outer casing, i.e., it may move along the outer casing so as to be switched between the first state and the second state.

In addition, the driving mechanism for moving the sealing cover may be of a structure as mentioned above, and thus will not be particularly defined herein.

The present disclosure further provides in some embodiments a method for operating the above-mentioned vacuum-pumping device, which includes the steps of: moving the sealing cover to be in the second state to expose a plurality of through-holes, and pumping air out of the chamber via a pump in communication with the exposed through-holes; and sealing the chamber by moving the sealing cover to be in the first state when a vacuum degree within the chamber reaches a first predetermined value.

Optionally, the outer casing is provided with a first through-hole area and a second through-hole area. The step of moving the sealing cover to be in the second state to expose a plurality of through-holes and pumping the air out of the chamber via the pump in communication with the exposed through-holes includes: moving a sealing cap for the first through-hole area to be in the first state, and moving a sealing cap for the second through-hole area to be in the second state.

Subsequent to the step of sealing the chamber by moving the sealing cover to be in the first state when a vacuum degree within the chamber reaches a first predetermined value, the method further includes: moving the sealing cap for the second through-hole area to be in the first state, moving the sealing cap for the first through-hole area to be in the second state so as to expose a plurality of through-holes in the first through-hole area, and filling a gas into the chamber via another pump in communication with the exposed through-holes in the first through-hole area; and sealing the chamber by moving the sealing cap for the first through-hole area to be in the first state when the vacuum degree within the chamber reaches a second predetermined value.

To be specific, in the step of moving the sealing cap for the second through-hole area to be in the second state, merely parts of the through-holes in the second through-hole area are exposed, and in the step of moving the sealing cap for the first through-hole area to be in the second state, merely parts of the through-holes in the first through-hole area are exposed.

According to the method in the embodiments of the present disclosure, the sealing cover may be moved to seal parts of the through-holes in accordance with the practical need, and the vacuum-pumping operation or the gas-filling operation may be performed through the exposed through-holes at the same time. As a result, it is able to ensure the air-tightness of the chamber as well as the vacuum-pumping or gas-filling efficiency.

The above are merely the preferred embodiments of the present disclosure. Obviously, a person skilled in the art may make further modifications and improvements without departing from the spirit of the present disclosure, and these modifications and improvements shall also fall within the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vacuum-pumping device comprising:
an outer casing;
a chamber defined by the outer casing; and
a sealing cover;
wherein the outer casing comprises a through-hole region where a plurality of through-holes is provided; the sealing cover is connected to the outer casing and capable of moving between a first state in which the through-holes are covered by the sealing cover so as to seal the chamber, and a second state in which at least parts of the through-holes are not covered by the sealing cover so as to form channels for the chamber.

2. The vacuum-pumping device according to claim 1, wherein the through-hole region comprises a first through-hole area where a plurality of through-holes is provided and a second through-hole area where a plurality of through-holes is provided; and the sealing cover comprises a first sealing cap for the first through-hole area and a second sealing cap for the second through-hole area.

3. The vacuum-pumping device according to claim 1, wherein the sealing cover comprises a plurality of sealing caps, the number of the sealing caps is identical to the number of the through-holes, and the sealing caps correspond to the through-holes in a one to one manner; each of the sealing caps is capable of moving between a position where the through-hole corresponding to the each of the sealing caps is covered and a position where at least a portion of the through-hole corresponding to the each of the sealing caps is exposed.

4. The vacuum-pumping device according to claim 3, wherein in the first state,
each of the sealing caps is at the position where the through-hole corresponding to the each of the sealing caps is covered; and in the second state, at least parts of the sealing caps are each located at a position for exposing at least a portion of the corresponding through-hole.

5. The vacuum-pumping device according to claim 1, wherein the sealing cover is provided with a plurality of openings; in the first state, the through-hole region is covered by the sealing cover with the openings not overlapping the through-holes in the through-hole region; and in the second state, the through-hole region is covered by the sealing cover with the openings at least partially overlapping the through-holes in the through-hole region.

6. The vacuum-pumping device according to claim 1, wherein the sealing cover is of a shape identical to the through-hole region, and attached onto the outer casing in both the first state and the second state.

7. The vacuum-pumping device according to claim 1, further comprising a driving mechanism configured to drive the sealing cover to move between the first state and the second state.

8. The vacuum-pumping device according to claim 7, wherein the driving mechanism comprises a pump connected to the sealing cover via a pneumatic pipe and a pneumatic valve arranged on the pneumatic pipe.

9. A method for operating the vacuum-pumping device according to claim 1, comprising steps of:
moving the sealing cover to be in the second state to expose a plurality of through-holes, and pumping air out of the chamber via a pump in communication with the through-holes exposed outside of the sealing cover; and
sealing the chamber by moving the sealing cover to be in the first state when a vacuum degree within the chamber reaches a first predetermined value.

10. The method according to claim 9, wherein the through-hole region at the outer casing of the vacuum-pumping device comprises a first through-hole area where a plurality of through-holes is provided and a second through-hole area where a plurality of through-holes is provided; and the sealing cover comprises a first sealing cap for the first through-hole area and a second sealing cap for the second through-hole area;
wherein the step of moving the sealing cover to be in the second state to expose a plurality of through-holes, and pumping air out of the chamber via the pump in communication with the through-holes exposed outside of the sealing cover, comprises: moving the first sealing cap for the first through-hole area to be in the first state, and moving the second sealing cap for the second through-hole area to be in the second state.

11. The method according to claim 10, wherein subsequent to the step of sealing the chamber by moving the sealing cover to be in the first state when the vacuum degree within the chamber reaches the first predetermined value, the method further comprises:
moving the second sealing cap for the second through-hole area to be in the first state, moving the first sealing cap for the first through-hole area to be in the second state so as to expose a plurality of through-holes in the first through-hole area, and filling a gas into the chamber via another pump in communication with the through-holes exposed in the first through-hole area; and
sealing the chamber by moving the first sealing cap for the first through-hole area to be in the first state when the vacuum degree within the chamber reaches a second predetermined value.

12. The method according to claim 11, wherein in the step of moving the second sealing cap for the second through-hole area to be in the second state, merely parts of the through-holes in the second through-hole area are exposed outside of the second sealing cap;
in the step of moving the first sealing cap for the first through-hole area to be in the second state, merely parts of the through-holes in the first through-hole area are exposed outside of the first sealing cap.

13. The method according to claim 9, wherein the sealing cover comprises a plurality of sealing caps, the number of the sealing caps is identical to the number of the through-holes, and the sealing caps correspond to the through-holes in a one-to-one manner;
wherein the step of moving the sealing cover to be in the second state comprises: moving the sealing caps to positions where at least a portion of some of the through-holes is exposed;
the step of moving the sealing cover to be in the first state comprises: moving each of the sealing caps to a position where each of the sealing caps seals the corresponding through-hole.

14. The method according to claim 9, wherein the sealing cover is provided with a plurality of openings;
the step of moving the sealing cover to be in the second state comprises: moving the sealing cover until the openings in the sealing cover at least partially overlap the through-holes;
the step of moving the sealing cover to be in the first state comprises: moving the sealing cover until the openings in the sealing cover do not overlap the through-holes.
